(19) United States
(12) Patent Application Publication
(10) Pub. No.: US 2010/0124640 A1
(43) Pub. Date: May 20, 2010

(54) ENERGY-SAVING WRITING INSTRUMENT

(76) Inventors: Shih-Jen WANG, Taoyuan County (TW); Li Chu Chen, Taoyuan County (TW)

Correspondence Address: Guice Patents PLLC, 12647 Galveston Court #302, Manassas, VA, 20112, US

(21) Appl. No.: 12/620,643

(22) Filed: Nov. 18, 2009

(30) Foreign Application Priority Data
Nov. 18, 2008 (TW) 097220605

(51) Int. Cl. B43L 1/00; B32B 27/06; B32B 29/06; B32B 9/00

(52) U.S. Cl. 428/195.1; 428/421; 428/324; 428/446; 428/452

(57) ABSTRACT

The present invention relates to an energy-saving writing instrument comprises: a thin film layer; and an interface modification member that is applied on a surface of the thin film layer or is uniformly provided on the thin film layer; after being combined, the surface of the thin film layer is provided with functions of allowing a pencil, ball pen, water-based pen or oil-based pen writing thereon and wiping off.

### BACKGROUND OF THE INVENTION

1. Field of the Invention

The present invention relates to an energy-saving writing instrument, more particularly to an energy-saving writing instrument having functions of being written thereon, and written texts and/or patterns can be widely wiped off and having advantages of thermal resistance, anti-dirt or waterproof.

2. Description of Related Art

Conventional objects for a purpose of writing are generally papers, and papers are made of pulp. But the pulp is obtained by cutting down green forests or plants, and papers, regardless newly-made or re-used, need large amount of energy and result in concerns of environmental protection. With less available resources in the earth and energy-saving and carbon reduction are emphasized, so how to let papers can be repeatedly used by writing with pens is an important issue for environmental protection and energy-saving and carbon reduction.

A conventional stick-on notepaper, e.g. the Post-it® notepaper made by 3M, is a paper with glue coated on a part of the backside thereof, so as to be stuck on a wall, tabletop, window or door panel, but texts and/or patterns written on said Post-it® notepaper can not be wiped off unless it is written by a pencil, so a reusable function is not completely provided; thus consumers may have to spend more money buying said notepaper and environmental protection and energy-saving issues are therefore occurred. With the energy-saving writing instrument having spot glues on its backside, disadvantages of conventional stick-on papers can be improved.

After texts and/or patterns are written on a piece of paper with pencils, an eraser can be used to erase in a small area, if a large area is desired to be erased, it may take longer time and the paper is more likely broken; or writing with a ball pen, a correction fluid or correction strip can be used to erase in a small area, if a large area is desired to be erased, it also may take longer time and result in more cost and the environmental protection issue is occurred.

Therefore developing a novel energy-saving writing instrument to improve the mentioned disadvantages is needed.

### SUMMARY OF THE INVENTION

One primary object of the present invention is to provide an energy-saving writing instrument for being written thereon and written texts and/or patterns can be widely erased and having advantages of thermal resistance, anti-dirt or waterproof.

Another object of the present invention is to provide an energy-saving writing instrument capable of being repeatedly used.

For achieving the objects mentioned above, an energy-saving writing instrument is provided by the present invention comprises: a thin film layer; and an interface modification member that is applied on a surface of the thin film layer or is uniformly provided on the thin film layer; after being combined, the surface of the thin film layer is provided with functions of allowing a pencil, ball pen, water-based pen or oil-based pen writing thereon and wiping off.

For achieving the objects mentioned above, an energy-saving writing instrument is provided by the present invention comprises: a sheet member; and an interface modification member that is applied on a surface of the sheet member or is uniformly provided on the sheet member; after being combined, the surface of the sheet member is provided with functions of allowing a pencil, ball pen, water-based pen or oil-based pen writing thereon and wiping off.

### BRIEF DESCRIPTION OF THE DRAWINGS

FIG. 1 is a schematic exploded view of the energy-saving writing instrument of one preferred embodiment of the present invention;

FIG. 2 is a schematic assembled view of the energy-saving writing instrument of one preferred embodiment of the present invention;

FIG. 3 is a schematic cross sectional view of the energy-saving writing instrument shown in FIG. 2;

FIG. 4 is a schematic exploded view of the energy-saving writing instrument of another preferred embodiment of the present invention;

FIG. 5 is a schematic assembled view of the energy-saving writing instrument of another preferred embodiment of the present invention;

FIG. 6 is a schematic cross sectional view of the energy-saving writing instrument shown in FIG. 5.

### DETAILED DESCRIPTION OF THE PREFERRED EMBODIMENT

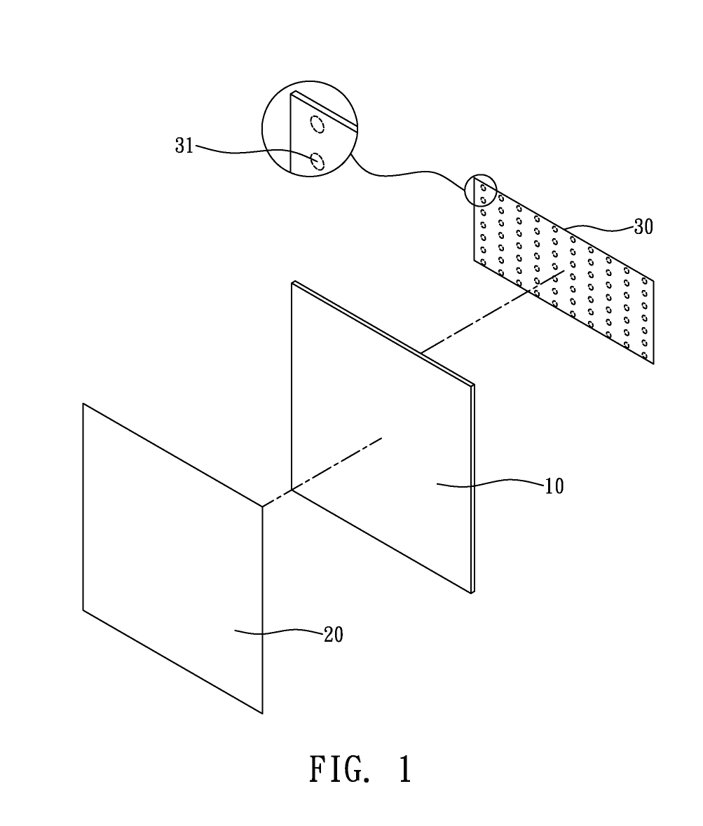

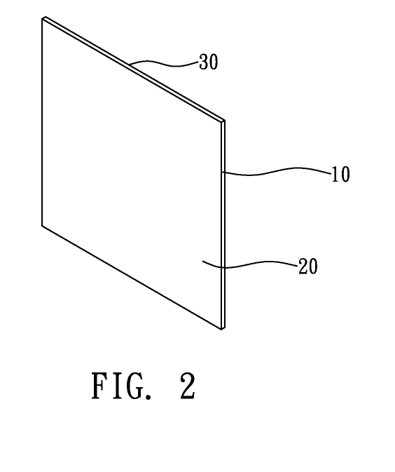

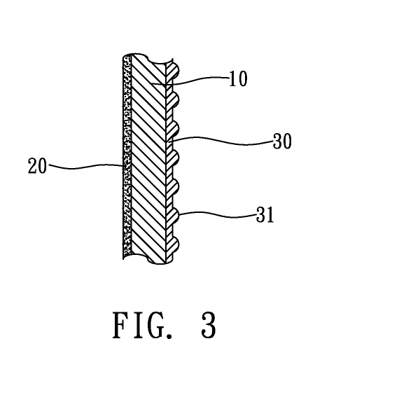

Referring from FIG. 1 to FIG. 3, wherein FIG. 1 is a schematic exploded view of the energy-saving writing instrument of one preferred embodiment of the present invention; FIG. 2 is a schematic assembled view of the energy-saving writing instrument of one preferred embodiment of the present invention; FIG. 3 is a schematic cross sectional view of the energy-saving writing instrument shown in FIG. 2.

As shown in figures, the energy-saving writing instrument provided by the present invention comprises: a thin film layer 10; and an interface modification member 20.

The thin film layer 10 is a piece of paper or a plastic film, wherein the plastic film is, e.g. but not limited to, PET, PVC, Nylon, PI, TPU, PE, PP or Teflon.

The interface modification member 20 is applied on one surface of the thin film layer 10 with a laying means, e.g. but not limited to the upper surface, or is uniformly provided on the thin film layer 10; in this embodiment, the laying means for applying the interface modification member 20 on the thin film layer 10 is adopted as an illustration but not as a limitation for other feasible means.

The interface modification member 20 is, e.g. but not limited to, polymer containing silicon or fluorine, oligomer, an interfacial active agent containing silicon or fluorine or abrasion proof powder; wherein the abrasion proof powder is, e.g. but not limited to, silicon dioxide, calcium carbonate, metal powder or mica powder.

The interface modification member 20 is served to modify the surface of the energy-saving writing instrument of the present invention, thus the surface thereof is able to be written with a pencil, ball pen, water-based pen or oil-based pen, and the surface of the energy-saving writing instrument of the present invention is provided with functions of anti-dirt, anti-scratch and thermal resistance, so the energy-saving writing instrument can be adhered on a floor, door panel, tabletop, or wall for protecting the floor, door panel, tabletop or wall. The thin film layer 10 is further provided with additive having various colors (not shown) for satisfying consumers' needs.

After the modification, the surface of the thin film layer 10, regardless its material of paper or plastic, is able to be written with a pencil, ball pen, water-based pen or oil-based pen, and texts and/or patterns written thereon is able to be widely wiped off with paper or cloth, so the thin film layer 10 is provided with a rewritable function, for example being used as a piece of paper for calculation, therefore objects of rewritable and energy-saving and carbon reduction are achieved, and the paper is protected from being damaged and cost of using correction fluids or correction strips is reduced and environmental protection is also considered.

The energy-saving writing instrument provided by the present invention is further installed with a spot glue layer 30 on the other surface of the thin film layer 10, e.g. but not limited to the lower surface, the spot glue layer 30 is installed with a plurality of spot glues 31 so as to be glued on a surface, e.g. but not limited to a tabletop, door panel, floor or wall, so that the tabletop, door panel, floor or wall is able to be written with different types of pens and be wiped off, and is also provided with functions of abrasion proof, thermal resistance and waterproof. The spot glue layer 30 is made of, e.g. but not limited to, acrylic glue, silicon glue, PU glue or rubber glue, and the spot glue layer 30 is further provided with additive having various colors (not shown) and the spot glues are able to be arranged to a regular, irregular or certain pattern. Moreover, the energy-saving writing instrument of the present invention is also able to be adhered on a surface of a table pad through the spot glue layer 30, so the table pad is provided with a writeable function. As mentioned, the energy-saving writing instrument provided by the present invention is novel compared to conventional writing instruments.

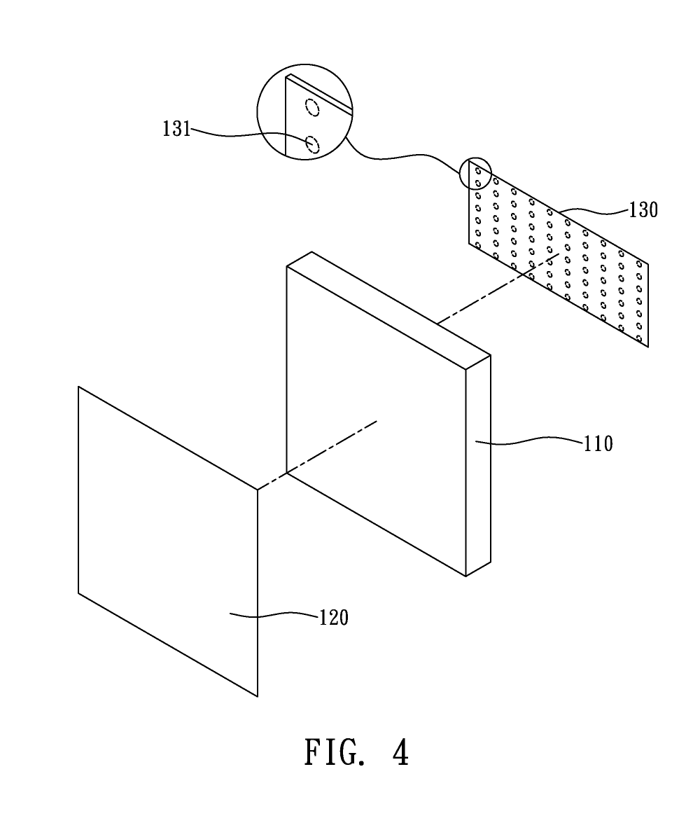

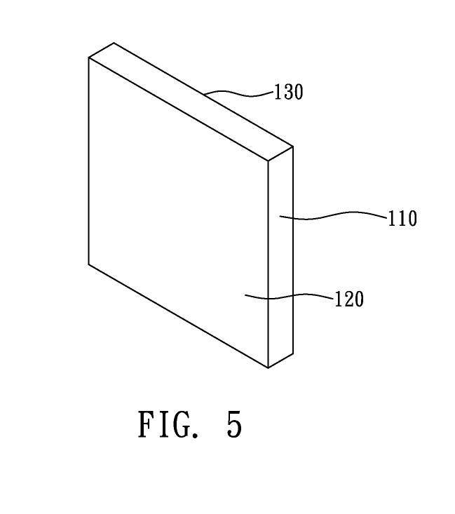

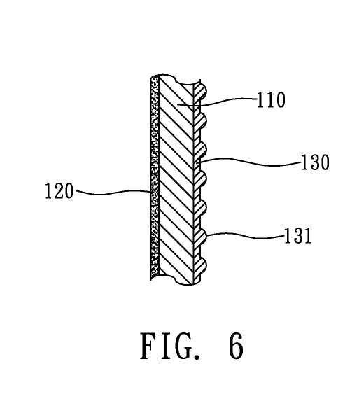

Referring from FIG. 4 to FIG. 6, wherein FIG. 4 is a schematic exploded view of the energy-saving writing instrument of another preferred embodiment of the present invention; FIG. 5 is a schematic assembled view of the energy-saving writing instrument of another preferred embodiment of the present invention; FIG. 6 is a schematic cross sectional view of the energy-saving writing instrument shown in FIG. 5.

As shown in figures, the energy-saving writing instrument provided by the present invention comprises a sheet member 110; and an interface modification member 120.

The sheet member 110 can be made of wood, metal, plastic or rubber.

The interface modification member 120 is applied on a surface of the sheet member 110 with a laying means, e.g. but not limited to the upper surface, or is uniformly coated on the sheet member 110; in this embodiment, the laying means for applying the interface modification member 120 on the sheet member 110 is adopted as an illustration but not as a limitation for other feasible means. So after being combined, the surface of the sheet member 110 is provided with functions of anti-dirt, thermal resistance, anti-scratch, and able to be written with a pen and wiped off.

The interface modification member 120 is, e.g. but not limited to, polymer containing silicon or fluorine, oligomer, an interfacial active agent containing silicon or fluorine or abrasion proof powder; wherein the abrasion proof powder is, e.g. but not limited to, silicon dioxide, calcium carbonate, metal powder or mica powder.

The interface modification member 120 is served to modify the surface of the sheet member 110, thus the surface of the sheet member 110 is able to be written with a pencil, ball pen, water-base pen or oil-based ball pen, and is provided with functions of anti-dirt, anti-scratch, waterproof and thermal resistance. Moreover, the sheet member 110 is further provided with additive having various colors (not shown) for satisfying consumers' needs.

After the modification, the surface of the sheet member 110 is able to be written with a pencil, ball pen, water-based pen or oil-based pen, and texts and/or patterns written thereon is able to be widely wiped off with paper or cloth, so objects of rewritable and energy-saving and carbon reduction are achieved, and the cost of using correction fluids or correction strips is reduced and environmental protection is also considered.

The energy-saving writing instrument provided by the present invention is further installed with a spot glue layer 130 on the other surface of the sheet member 110, e.g. but not limited to the lower surface, the spot glue layer 130 is installed with a plurality of spot glues 131 so as to be glued on a surface, e.g. but not limited to a tabletop, door panel or wall. The spot glue layer 130 is made of acrylic glue, silicon glue, PU glue or rubber glue, and is further provided with additive having various colors (not shown), and the spot glues 131 are able to be arranged to a regular, irregular or certain pattern. As mentioned, the energy-saving writing instrument provided by the present invention is novel compared to conventional writing instruments.

The energy-saving writing instrument of the present invention has writeable function, and written texts and/or patterns can be widely wiped off, advantages of thermal resistance, anti-dirt or waterproof are also provided. Therefore the energy-saving writing instrument of the present invention is novel compared to conventional writing instruments.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An energy-saving writing instrument, comprising:
a thin film layer; and
an interface modification member applied on a surface of said thin film layer or uniformly provided on said thin film layer; after being combined, the surface of said thin film layer being provided with functions of allowing a pencil, ball pen, water-based pen or oil-based pen writing thereon and wiping off.

2. The energy-saving writing instrument as claimed in claim 1, wherein said thin film layer is a piece of paper or a plastic film.

3. The energy-saving writing instrument as claimed in claim 2, wherein when said thin film layer is a piece of paper, the surface thereof is able to be written with a pencil, ball pen, water-based pen or oil-based pen and able to be widely wiped off with a wiper or soft paper; when said thin film layer is a plastic film, the surface thereof is able to be written with a water-based pen or oil-based pen and able to be widely wiped off with a wiper or soft paper.

4. The energy-saving writing instrument as claimed in claim 2, wherein the plastic film is PET, PVC, Nylon, PI, TPU, PE, PP or Teflon.

5. The energy-saving writing instrument as claimed in claim 1, wherein said thin film layer is further provided with additive having various colors.

6. The energy-saving writing instrument as claimed in claim 1, wherein said interface modification member is polymer containing silicon or fluorine, oligomer, an interfacial active agent or abrasion proof powder, wherein said abrasion proof powder is silicon dioxide, calcium carbonate, metal powder or mica powder.

7. The energy-saving writing instrument as claimed in claim 1, wherein further comprising a spot glue layer on the other surface of said thin film layer, said spot glue layer is installed with a plurality of spot glues so as to be glued on a surface, and said spot glue layer is made of acrylic glue, silicon glue, PU glue or rubber glue, and said spot glue layer is further provided with additive having various colors, and said spot glues are arranged to a regular, irregular or certain pattern.

8. The energy-saving writing instrument as claimed in claim 1, wherein said energy-saving writing instrument is served to be adhered on a floor, door panel, tabletop or wall for increasing capacities of anti-dirt, thermal resistance, waterproof and anti-scratch.

9. An energy-saving writing instrument, comprising:
a sheet member; and
an interface modification member applied on a surface of said sheet member or uniformly provided on said sheet member; after being combined, said surface of said sheet member being provided with functions of allowing a pencil, ball pen, water-based pen or oil-based pen writing thereon and wiping off.

10. The energy-saving writing instrument as claimed in claim 9, wherein said sheet member is made of wood, metal, plastic or rubber, and said surface thereof is able to be written with a pencil, ball pen, water-based pen or oil-based pen and able to be widely wiped off with a wiper or soft paper.

11. The energy-saving writing instrument as claimed in claim 10, wherein said plastic is PET, PVC, Nylon, PI, TPU, PE, PP or Teflon.

12. The energy-saving writing instrument as claimed in claim 9, wherein said interface modification member is polymer containing silicon or fluorine, oligomer, an interfacial active agent or abrasion proof powder, wherein said abrasion proof powder is silicon dioxide, calcium carbonate, metal powder or mica powder.

13. The energy-saving writing instrument as claimed in claim 9, wherein further comprising a spot glue layer installed on the other surface of said sheet member, a plurality of spot glues are provided thereon so as to be adhered on a surface.

14. The energy-saving writing instrument as claimed in claim 13, wherein said spot glue layer is made of acrylic glue, silicon glue, PU glue or rubber glue, and said spot glue layer is further provided with additive having various colors, and said spot glues are arranged to a regular, irregular or certain pattern.
